(19) United States
(12) Patent Application Publication
(10) Pub. No.: US 2004/0138849 A1
(43) Pub. Date: Jul. 15, 2004

(54) Load sensing surface as pointing device

(76) Inventors: Albrecht Schmidt, Crailsheim (DE); Kristof Van Laerhoven, Essen (BE); Hans-W. Gellersen, Lancaster (GB); Martin Strohbach, Lancaster (GB); Uwe Kubach, Waldbronn (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/671,422

(22) Filed: Sep. 26, 2003

Related U.S. Application Data
(60) Provisional application No. 60/414,330, filed on Sep. 30, 2002.

(51) Int. Cl. G06F 15/00

(52) U.S. Cl. 702/127

(57) ABSTRACT

Methods and systems for using a load sensing surface as a pointing device for a computer are described. For example, a plurality of sensors may be used to sense force distribution information at points on a substantially continuous surface, and a pointer manager may be used to map the force distribution information to pointing information for display on a computer screen. In this way, a pointing device for a computer may be integrated with common elements, such as a table.

### CROSS-REFERENCE TO RELATED APPLICATIONS

This application claims priority to U.S. Provisional Application Serial No. 60/414,330, filed on Sep. 30, 2002, and titled LOAD SENSING SURFACE AS POINTING DEVICE.

### TECHNICAL FIELD

This description relates to using a load sensing surface as a pointing device.

### BACKGROUND

Computer users may interact with many computer applications using pointing devices. For example, an external device connected to a computer, such as a computer mouse, may be actuated, and those actuations may be translated into “pointing” and “clicking” events. Computer protocols, such as the Microsoft mouse protocol, may translate the pointing and clicking events into instructions that influence the operation of the applications. Pointing devices also may be packaged with a particular computer. For example, a trackpad pointing device using touch senors may be integrated with a portable computer.

A pointing device may be integrated with a common surface, such as a table. For example, a touch screen device, similar to a trackpad pointing device, may be integrated with the table. The table also may be used in conjunction with an additional object as a pointing device. For example, the position of an object on the table that is augmented with a barcode tag may be monitored and translated into pointing and clicking information.

Load sensing includes measuring the force or pressure applied to a surface. It may be used, for example, to measure the weight of goods, to monitor the strain on structures, and to gauge filling levels of containers. A segmented surface, such as a floor with load cells placed beneath each of several segments, may be used to input information into a computer. For example, the pressure information from the load cells may be used as input to a computer game.

### SUMMARY

In one general aspect, a method includes measuring force distribution information at a plurality of points on a substantially continuous surface, processing the force distribution information to identify events on the surface, and mapping the events to pointing device behavior.

Implementations may include one or more of the following features. For example, in processing the force distribution information, a center of pressure of a total force on the surface may be calculated.

An increase in a sum of forces measured at each of the plurality of points may be detected, and it may be determined that the increase in the sum of the forces is between a lower threshold and an upper threshold so that the fact that the surface is being touched may be identified, based on the increase in the sum of the forces. In this case, a decrease in the sum of the forces may be detected, and the fact that the surface is no longer being touched may be identified, based on the decrease in the sum of the forces.

Changes in the force distribution information at the plurality of points may be monitored for a period of time, and it may be determined that that a sum of the changes for the period of time is less than a threshold, so that the fact that there is no interaction on the surface may be identified.

Changes in the force distribution information at the plurality of points may be monitored for a period of time, a change in the center of pressure may be identified, and the change in the center of pressure may be mapped to pointing device movement.

An increase in a sum of forces measured at each of the plurality of points may be detected, a subsequent decrease in the sum of forces measured at each of the plurality of points may be detected, and a mouse click event may be identified, based on the increase and subsequent decrease in the sums of forces.

A pre-load force distribution on the surface may be measured, and the pre-load force distribution may be subtracted from the force distribution information, prior to computing the center of pressure.

In another general aspect, a system includes a plurality of sensors operable to sense force distribution information at points on a substantially continuous surface, and a pointer manager to map the force distribution information to pointing information.

Implementations may include one or more of the following features. For example, the surface may be a table, and a location determiner may be included that is operable to determine a center of pressure of the force distribution.

The surface may be rectangular, and the plurality of sensors may include a sensor located at each corner of the rectangular surface. In this case, an analog to digital converter may be included that is operable to convert analog signals from the sensors to digital signals. Further, a communication device may be included that is operable to communicate the digital signals to a computer. The communication device may include a RF transceiver, and the computer may include a mouse emulator to translate the digital signal into mouse pointing events.

A second set of sensors may be included that are operable to sense force distribution information at points on a second substantially continuous surface, as well as a second pointer manager that is operable to map the force distribution information to pointing information. A computer may be included that includes a mouse emulator operable to translate the force distribution information from the first and second surfaces into a stream of mouse pointing events.

In another general aspect, an application includes a code segment operable to measure force distribution information at a plurality of points on a substantially continuous surface, a code segment operable to process the force distribution information to identify events on the surface, and a code segment operable to map the events to pointing device behavior.

Implementations may include one or more of the following features. For example, the application may include a code segment operable to detect an increase in a sum of forces measured at each of the plurality of points, a code segment operable to determine that the increase in the sum of the forces is between a lower threshold and an upper threshold, and a code segment operable to identify that the surface is being touched, based on the increase in the sum of the forces.

The application may include a code segment operable to monitor changes in the force distribution information at the plurality of points for a period of time, a code segment operable to identify a change in a center of force of the object, and a code segment operable to map the change in the center of force to pointing device movement.

The application may include a code segment operable to detect an increase in a sum of forces measured at the plurality of points, a code segment operable to detect a subsequent decrease in the sum of forces measured at the plurality of points, and a code segment operable to identify a mouse click event, based on the increase and subsequent decrease in the sums of forces.

The application may include a code segment operable to measure a pre-load force distribution on the surface, and a code segment operable to subtract the pre-load force distribution from the force distribution information prior to computing a center of pressure.

The details of one or more implementations are set forth in the accompanying drawings and the description below. Other features will be apparent from the description and drawings, and from the claims.

### DESCRIPTION OF DRAWINGS

FIG. 1 is a flow chart of a method of determining pointing device events.

FIG. 2 is a diagram of a load sensing surface.

FIG. 3 is a block diagram of a system for sensing position and interaction information.

FIG. 4 is a block diagram of a data packet.

FIG. 5 is a block diagram of a load sensing system.

FIG. 6 is a flow chart of a method of determining object location.

FIG. 7 is a more detailed flow chart of a method of determining object location.

FIG. 8 is diagram of pointing states.

FIG. 9 is a diagram of a system for processing pointing information from multiple load sensing surfaces.

### DETAILED DESCRIPTION

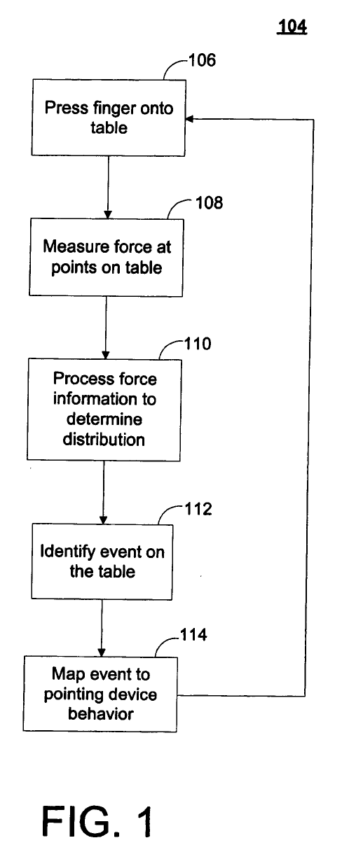

A continuous surface, such as a table, may be used as a pointing device for a computer. For example, FIG. 1 is a flow chart 104 of determining pointing device events (e.g., mouse events) from interactions with the table. A person may press her finger onto the table, exerting a force or pressure on the table (106). Force information may be measured at a plurality of points on the surface (108). This force information may be processed to determine the distribution of force on the table (110) and identify events on the surface (112). Those events may then be mapped to pointing device behavior (114).

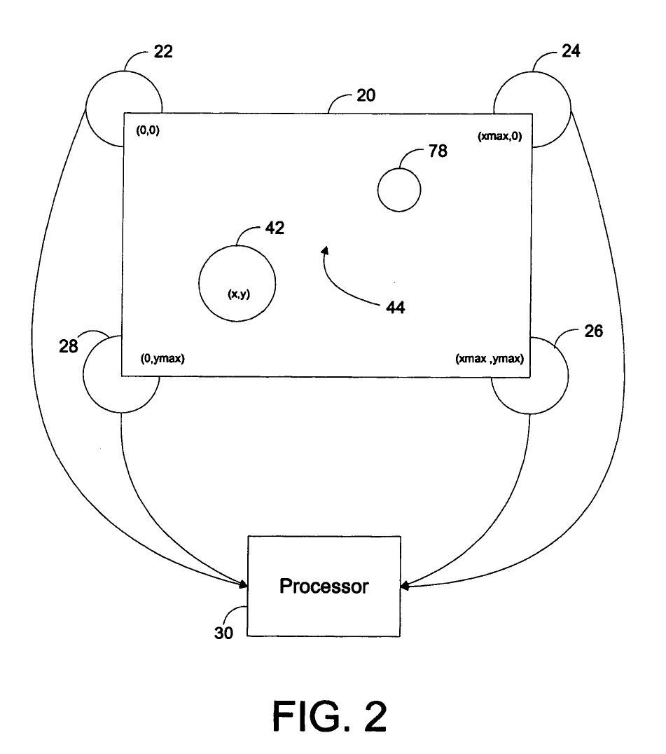

FIG. 2 shows a rectangular surface 20 having four load sensors 22, 24, 26, 28 which sense the force or pressure exerted on them by one or more objects placed on the surface 20, in accordance with the techniques of FIG. 1 (106, 108). The load sensors 22, 24, 26, 28 are placed at, or beneath, the four corners of the rectangular surface 20. Each load sensor generates a pressure signal indicating the amount of pressure exerted on it.

Specifically, each sensor 22, 24, 26, 28 may emit a voltage signal that is linearly dependant on the amount of force applied to it. The pressure signals may be sent to a processor 30, such as a microcontroller or a personal computer, which analyzes the signals. The surface 20 may represent many types of tables, where the sensors 22, 24, 26, 28 are selected to correspond to the particular table type(s). For example, the surface 20 may be a conventional dining type table top and the sensors 22, 24, 26, 28 may be load sensors that detect loads up to 50 kg. As another example, the surface 20 may be a coffee table top, and the sensors 22, 24, 25, 28 may be load sensors that detect loads up to 1 kg.

The sensors 22, 24, 26, 28 may be mounted between the table top and the supporting structure of the table. For example, they may be mounted to the table top and may rest on the legs of the table frame. Mechanical overload protection may be built into the table so that pointing is suspended when the force on the surface exceeds an upper limit. For example, the sensors 22, 24, 26, 28 may be configured with a metal spacer that may limit the amount the sensors may be compressed.

Together, the sensors 22, 24, 26, 28 may measure the distribution of force on the surface 20. In FIG. 2, an object 42 is shown placed on the surface 20. If the object is placed in the center 44 of the surface 20, the pressure at each of the corners of the surface will be the same. The sensors will then sense equal pressures at each of the corners. If, as FIG. 2 shows, the object 42 is located away from the center 44, closer to some corners than others, the pressure on the surface will be distributed unequally among the corners and the sensors will sense different pressures. For example, in FIG. 2, the object is located closer to an edge of the surface including sensors 22 and 28 than to an edge including sensors 24 and 26. Likewise, the object is located closer to an edge including sensors 26 and 28 than to an edge including sensors 22 and 24. The processor 30 may then evaluate the pressures at each of the sensors 22, 24, 26, 28 to determine the location of the object 42.

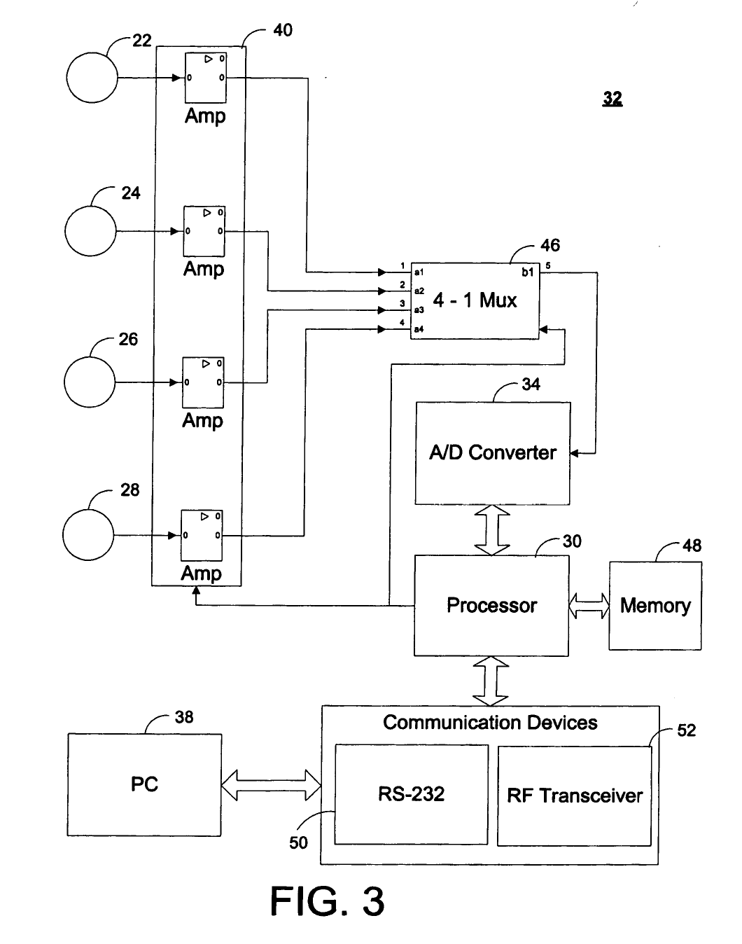

FIG. 3 shows a system 32 for sensing position and interaction information, with respect to objects on the surface 20. Each sensor 22, 24, 26, 28 outputs an analog signal that is converted to a digital signal by, for example a standard 16-bit analog to digital converter (ADC) 34. The ADC 34 links to a serial line of a personal computer (PC) 38. Thus, in the example of FIG. 3, each sensor 22, 24, 26, 28 senses the force applied to it and generates a voltage signal that is proportional to that force, whereupon each signal is amplified by a discrete amplifier forming part of block 40 and sampled by the ADC 34, and the sampled signal is communicated to the processor 30 for processing.

In FIG. 3, the load cells 22, 24, 26, 28 used to sense position and interaction information may use resistive technology, such as a wheat stone bridge that provides a maximum output signal of 20 mV when powered by a voltage of 5V. The signals may be amplified by a factor of 220, to an output range of 0 to 4.4V, using LM324 amplifiers 40. Alternatively, instrumentation amplifiers, such as an INA118 from Analog Devices may be used. Each amplified signal may be converted into a 10-bit sample at 250 Hz by the ADC 34, which may be included in the processor 30. Alternatively, the ADC 34 may be a higher resolution external 16-bit ADC, such as the ADS8320, or a 24-bit ADC. A multiplexer 46 may be used to interface several sensors 22, 24, 26, 28 with a single ADC 34. The processor 30 may identify the location of objects, or detect events, and send location and event information to the PC 38.

The location and event information may be sent using serial communication technology, such as, for example, RS-232 technology 50, or wireless technology, such as a RF transceiver 52. The RF transceiver 52 may be a Radiometrix BIM2 that offers data rates of up to 64 kbits/s. The information may be transmitted at lower rates as well, for example 19,200 bits/s. The RF transceiver 52 may, alternately, use Bluetooth technology. The event information may be sent as data packets.

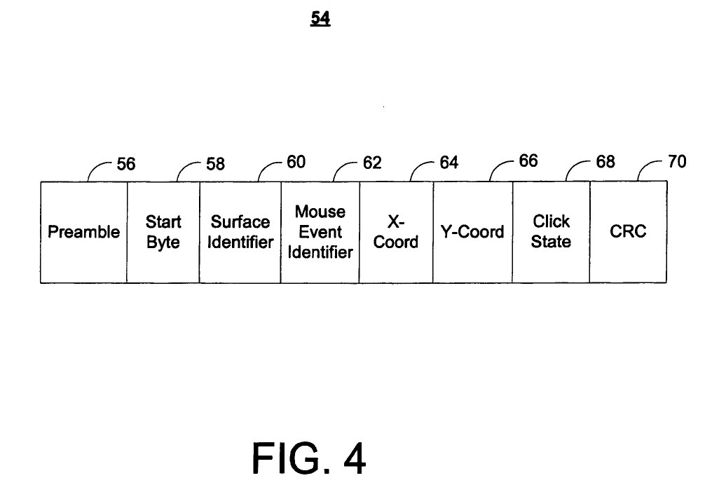

FIG. 4 shows a data packet 54, which includes a preamble 56, a start-byte 58, a surface identifier 60 to identify the surface on which the event information was generated, a mouse event identifier 62 indicating a type of pointing event, an x coordinate 64 of the center of pressure of the mouse event, a y coordinate 66 of the center of pressure of the mouse event, and a click state 68. The data packet 54 also may include two bytes of a 16-bit CRC 70 to ensure that the transmitted data is correct.

The processor 30 may be configured with parameters such as the size of the surface, a sampling rate, and the surface identifier 60. The PC 38 may send such configuration information to the processor 30 using, for example, the serial communication device 50 or 52. The configuration information may be stored in a processor memory forming part of the processor 30.

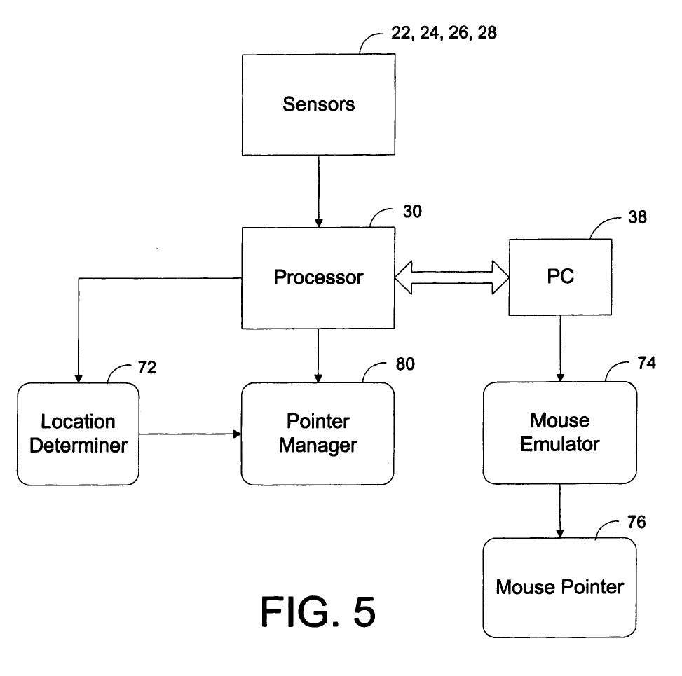

As FIG. 5 shows, software modules may interact with the processor 30. For example, a location determiner, which may be a location determiner software module 72, may be used to calculate the pressure on the surface 20 based on information from the sensors 22, 24, 26, 28. The location determiner 72 may include, for example, a Visual Basic program that reads periodically from the ADC 34 and calculates the center of pressure exerted by the object 42.

A mouse emulator 74 using a mouse protocol, such as the Microsoft mouse protocol, may be used to translate the information in the data packets 54 to instructions for applications running on the PC 38. For example, the mouse emulator 74 may control the behavior of a mouse pointer 76. Microsoft mouse protocol uses three 7 bit words to represent the pointing and clicking information, such as the relative movement of the pointer 76 since a previous packet was received.

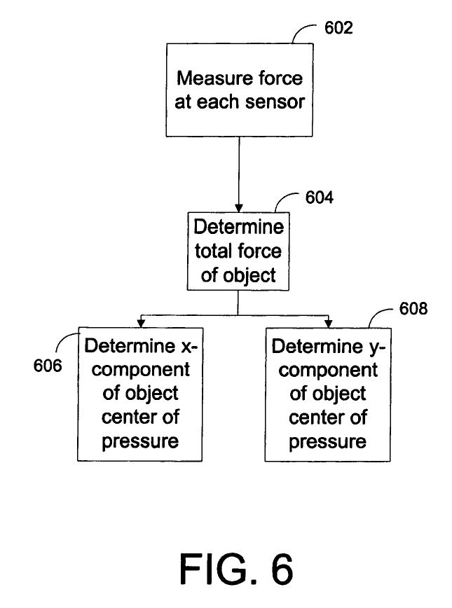

FIG. 6 shows a method of determining the location of an object 42 using the location determiner 72. The pressure is measured at each of the sensors 22, 24, 26, 28 (602). The pressure at each sensor 22, 24, 26, 28 may be represented as F₂₂, F₂₄, F₂₆, and F₂₈ respectively. The location determiner 72 calculates the total pressure on the surface 20 (604) and determines directional components of the location of the object 42.

For example, the location determiner 72 may determine a component of the location of the object 42 that is parallel to the edge of the surface that includes sensors 26 and 28 (the x-component) (606), and a component of the location perpendicular to the x-component and parallel to the edge of the surface including sensors 24 and 26 (the y-component) (608). The center of pressure of the object 42 is determined as the point on the surface identified by an x-coordinate and a y-coordinate of the location of the object.

For example, the position of sensor 22 may be represented by the coordinates (0, 0), the position of sensor 24 may be represented by the coordinates (xₘₐₓ, 0), the position of sensor 26 may be represented by the coordinates (xₘₐₓ, yₘₐₓ), and the position of sensor 28 may be represented by the coordinates (0, yₘₐₓ), where xₘₐₓ and yₘₐₓ are the maximum values for the x and y coordinates (for example the length and width of the surface 20). The position of the center of pressure of the object 42 may be represented by the coordinates (x,y).

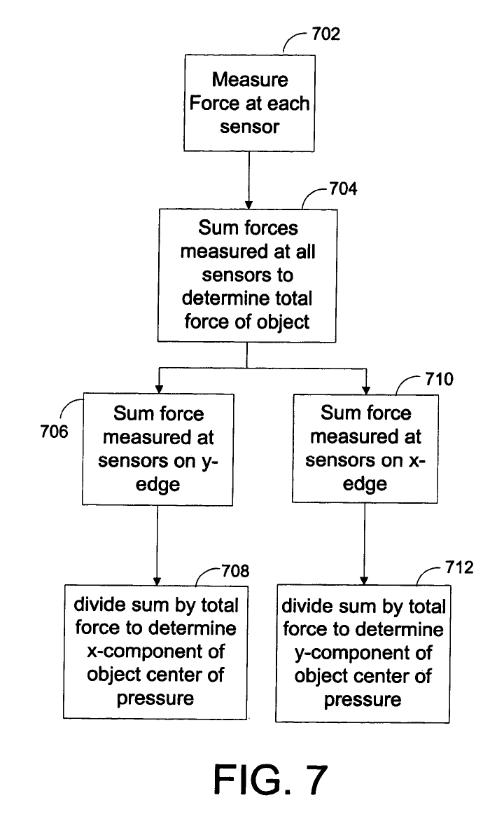

FIG. 7 shows a more detailed method of determining the location of the object 42. Specifically, the total pressure on the surface (Fₓ) is computed by measuring pressure at each of the sensors 22, 24, 26, 28 (702), and then summing the pressures (704):

Fₓ=F₂₂+F₂₄+F₂₆+F₂₈

The x- coordinate (x) is determined by first summing the pressure measured at sensors located along an edge parallel to the y-component (for example, sensors 24 and 26) (706). The sum may then be divided by the total pressure on the surface to determine the x- coordinate of the center of pressure of the object (708):

$$x = {x}_{max} \frac{{F}_{24} + {F}_{26}}{{F}_{x}}$$

Likewise, the y- coordinate (y) of the center of pressure may be determined by first summing the pressure measured at sensors located along an edge parallel to the x-component (for example sensors 26 and 28) (710). The sum may then be divided by the total pressure on the surface to determine the y- coordinate of the center of pressure of the object (712):

$$y = {y}_{max} \frac{{F}_{26} + {F}_{28}}{{F}_{x}}$$

The surface 20 itself may exert a pressure, possibly unevenly, on the sensors 22, 24, 26, 28. Similarly, as FIG. 2 shows, an object 78, already present on the surface 20, may exert a pressure, possibly unevenly, on the sensors. Nonetheless, the location determiner 72 may still calculate the location of the object 42 by taking into account the distribution of pressure existing on the surface 20 (or contributed by the surface 20) prior to the placement of the object 42 on the surface 20. The location determiner 72 may calculate the location of the object 42 even if it is placed on top of the object 78. Pre-load values at each of the sensors 22, 24, 26, 28 may be measured, and the total pressure (F0ₓ) on the surface 20 prior to placement of the first object 42 may be determined by summing the pre-load values (F0₂₂, F0₂₄, F0₂₆, F0₂₈) at each of the sensors 22, 24, 26, 28:

F0ₓ=F0₂₂+F0₂₄+F0₂₆+F0₂₈

The x- coordinate of the center of pressure of the first object may be determined by subtracting out the contributions to the pressure made by the second object 74 (or by the surface 20 itself):

$$x = {x}_{max} \frac{( {F}_{24} - {F0}_{24} ) + ( {F}_{26} - {F0}_{26} )}{( {F}_{x} - {F0}_{x} )}$$

The y- coordinate of the center of pressure of the first object may be determined similarly:

$$y = {y}_{max} \frac{( {F}_{26} - {F0}_{26} ) + ( {F}_{28} - {F0}_{28} )}{( {F}_{x} - {F0}_{x} )}$$

The sensors 22, 24, 26, 28 may include a mechanism for subtracting out the preload value, or tare.

Using the force information from the sensors 22, 24, 26, 28 and the location determiner 72, a pointer manager 80 may map the behavior on the surface 20, which may include mouse events, to states. The states may be used to determine pointer 76 movement. Thus, the pointer manager 80 may translate changes to the force on the surface 20, as measured by the sensors 22, 24, 26, 28, into pointer movements and events. As FIG. 5 shows, the pointer manager 80 may be a software module controlled by the processor 30.

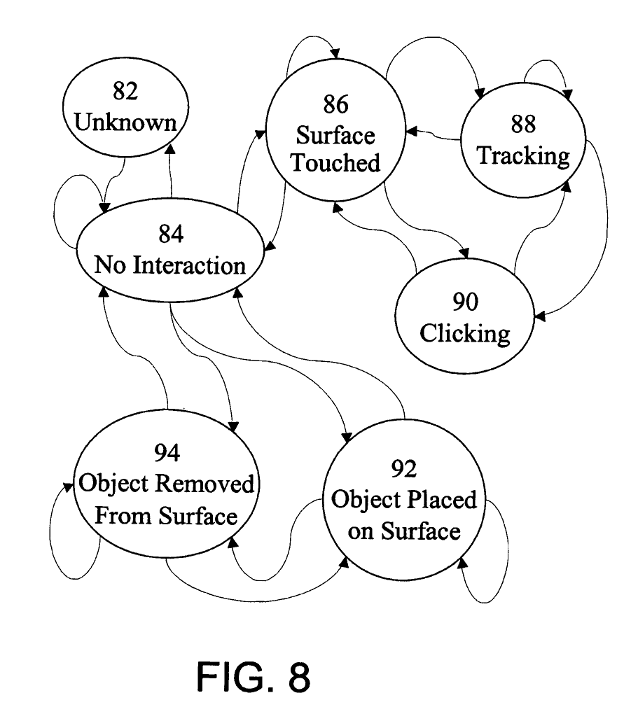

FIG. 8, for example, is a diagram showing states that the events may be mapped to. When the pointer manager 80 begins monitoring the behavior on the surface 20, it may not be able to determine the nature of the behavior. In this case, the behavior may be mapped to an “unknown” state 82. After the surface 20 settles, the behavior may be mapped to a “no interaction” state 84. When the surface 20 is touched, for example by a finger, the event may be mapped to a “surface touched” state 86. When the finger, still touching the surface, moves, the event may be mapped from the “surface touched” state 86 to a “tracking” state 88, where the movement of the finger may be tracked. On the other hand, if the finger is removed from the surface 20, the event may be mapped from the “surface touched” state 86 back to the “no interaction” state 84. If the finger remains on the surface (i.e. the behavior is mapped to the “surface touched” state 86 or “tracking” state 88) and the finger presses down and releases, the event may be mapped to a “clicking” state 90.

Other behavior on the surface 20 besides pointing activity may be monitored as well. For example, if an object is placed on the surface 20, the event may be mapped to an “object placed on surface” state 92. Likewise, if an object is removed from the surface, the event may be mapped to an “object removed from surface” state 94. While in these states 92, 94, the pointer manager 80 may take note of the addition or removal to take into account in further processing. When the surface 20 settles, the behavior may be mapped back into the “no interaction” state 84.

The pointer manager 80 may monitor the force information on the surface 20 at different points in time to monitor the behavior on the surface 20. As the force information changes, the behavior may be mapped to appropriate states accordingly. The force information sensed by the sensors 22, 24, 26, 28 with respect to time may be used to map the behavior on the surface 20 to the appropriate states. The force measured at each sensor 22, 24, 26, 28 with respect to time may be represented by F₂₂(t), F₂₄(t), F₂₆(t), F₂₈(t), respectively. The force information may be sampled at discrete intervals. The center of pressure on the surface 20 may be measured as described above by the location determiner 72. The position of the center of pressure with respect to time may be represented as p(t), or in terms of the coordinates x(t) and y(t).

When the force measured at each of the sensors 22, 24, 26, 28 is not changing, the behavior may be mapped to the “no interaction” state 84. For example, when the sums of the absolute changes of the forces measure at each points over the previous n sampling points is close to zero (less than a threshold value ε), the pointer manager may determine that surface 20 is stable, and the behavior may be mapped to the “no interaction” state. The threshold value ε may be chosen based on actual or anticipated noise. This calculation may be represented by the following equation:

$${\sum }_{i = 1 … 4} {\sum }_{j = ( t - n ) … ( t - 1 )} \vert {F}_{i} ( t ) - {F}_{i} ( j ) \vert < ϵ$$

As long as the surface 20 is stable, the behavior may be mapped to the “no interaction” state 84. The threshold value ε may be chosen to be greater for remaining in the “no interaction” state 84 than for entering the “no interaction” state 84 so that minimal changes on the surface 20 may be monitored. The pre load values F0₂₂, F0₂₄, F0₂₆, and F0₂₈ may also be set during the “no interaction” state 84.

When the pointer manager 80 recognizes that a finger has been placed on the surface 20, the behavior is mapped to the “surface touched” state 86. The transition from the “no interaction” state 84 to the “surface touched” state 86 may be characterized by a monotonous increase in the sum of the forces measured with respect to time Fₓ(t). The pointer manager 80 may calculate the derivative of the sum of the force with respect to time. A derivative value greater than zero indicates an increase in force. Alternately, the pointer manager 80 may compare the force measured at different points in time and determine that Fₓ is increasing with respect to time: Fₓ(t)<Fₓ(t+1). The pointer manager 80 may further determine that the amount of force Fₓ adjusted for the pre load value F0ₓ is within an interval (Dₘᵢₙ, Dₘₐₓ):

(F(t)ₓ−F0(t)ₓ>Dₘᵢₙ) [symbol] (F(t)−F0(t)ₓ<Dₘₐₓ)

Thus, the pointer manager 80 may identify a transition from the “no interaction” state 84 to the “surface touched” state 86 if there is an increase in the force on the surface with respect to time and that force is within the interval (Dₘᵢₙ, Dₘₐₓ). The pointer manager 80 may continue to map the behavior to the “surface touched” state 86 for as long as the adjusted amount of force is within the interval (Dₘᵢₙ, Dₘₐₓ). However, because there is manual interaction on the surface 20, and the forces on the surface 20 may not remain stable, the pointer manager 80 may also calculate the absolute values of the changes of the forces over the last n sampling points to determine if the finger is still on the surface 20, and whether the finger is still moving.

For example, if the sum of the absolute values of the changes in force over time is greater than a threshold δ, the behavior on the surface 20 may be mapped to the “surface touched” state 86. Likewise, if the sum of the absolute values of the changes in position over time is less than a threshold ε, the pointer manager 80 may determine that the finger is not moving, behavior on the surface 20 may be mapped to the “surface touched” state 86. These calculations may be characterized by equations:

$${\sum }_{j = ( t - n ) … ( t - 1 )} \vert {F}_{x} ( t ) - {F}_{x} ( j ) \vert > δ$$

$$and$$

$${\sum }_{j = ( t - n ) … ( t - 1 )} \vert p ( t ) - p ( j ) \vert < ϵ$$

The pointer manager 80 may identify a transition from the “surface touched” state 86 to the “no interaction” state 84 by identifying a decrease in the sum of the forces measured with respect to time Fₓ(t). The pointer manager may calculate the derivative of the sum of the force with respect to time. A derivative value less than zero indicates an increase in force. Alternately, the pointer manager 80 may compare the force measured at different points in time and determine that Fₓ is decreasing with respect to time: Fₓ(t)>Fₓ(t+1). The pointer manager 80 may continue to map the behavior to the “no interaction” state 84 if the surface 20 remains stable for the most recent n sampling points, as described above.

The pointer manager 80 may also detect a change from the “surface touched” state 86 to any of the “no interaction” 84, “tracking” 88, and “clicking” 90 states. Further, when the behavior on the surface is mapped to the “tracking” state 88, the pointer manager measures a change in the measured center of pressure δₚ, as characterized by the following equation:

$${\sum }_{j = ( t - n ) … ( t - 1 )} \vert p ( t ) - p ( j ) \vert > {δ}_{p}$$

When the system 32 is in the “surface touched” 86 or “tracking” 88 states, and the finger presses down and releases, the pointer manager 80 may detected a mouse click event. The pointer manager 80 may map that behavior to a “clicking” state 90. The mouse click event may be characterized by an increase in the total force on the surface 20 followed by a decrease in the total force, all within a certain time span (i.e. one second). The center of pressure of the behavior on the surface 20 remains roughly the same. The increase in force may be within a predefined interval that separates the mouse click event from other changes that may occur while tracking. Thus the increase in force during a mouse click event should be greater than a lower threshold, but less than a higher threshold, to differentiate the mouse click event from other interactions with the surface 20.

The surface 20 may be used for other activities besides pointing. For example, if the surface 20 is a table, objects, such as books, may be placed on it. The pointer manager 80 may recognize this event, differentiate it from other events (such as a mouse click), and map the event to the “object placed on surface” state 92. The pointer manager 80 may detect an increase in the total force on the surface 20 followed by surface stability (minimal change of force on the surface) at the new total force. In the “object placed on surface” state 92 the pointer manager 80 may update the pre load values with the new force exerted by the new object.

After an object has been placed on the surface 20, the surface may still be used as a pointing device. For example, a book may be placed on the surface 20, the event may be mapped to the “object placed on surface” state 92, the pre-load values may be updated to account for the book, and the system 32 may be mapped to the “no interaction” state 84. When the finger presses on the book and moves across the surface of the book, the behavior may be mapped to the “surface touched” 86 and “tracking” 88 states, respectively.

The pointer manager 80 may similarly determine that an object has been removed from the surface, and map that event to the “object removed from surface” state 94. The pointer manager 80 detects a decrease in the total force on the surface 20 followed by surface stability at the new total force. The pointer manager 80 may likewise update the pre load values to take into account the reduction in force on the surface 20 from the removal of the object.

Several state transition threshold values are described above. These values may be chosen based on a desired system response. The system 32 may be configured to require a greater or lesser certainty about the behavior on the surface 20 before a state transition is recognized by choosing appropriate threshold values. For example, when placing an object on the surface 20, the behavior on the surface 20 is similar to the initial behavior of the “tracking” state 88. The system 32 may be configured to wait until the behavior is definitively recognized as tracking before it is mapped to the “tracking” state 88, lessening the chance of erroneously mapping the behavior to the “tracking” state 88 but possibly introducing a delay in recognizing the behavior. On the other hand, the system 32 may be configured to immediately map the behavior to the “tracking” state 88, eliminating the delay, but increasing the risk of erroneously mapping the behavior to the “tracking” state 88. Likewise, the threshold values may be configured to require a greater or lesser certainty when mapping events to the “clicking” state 90.

As described above, common surfaces may be used to interface with computers. For example, the surface 20 may be a coffee style table which is lower to the ground than a dining style table. The computer user may move a finger on the coffee table 20 to control the mouse pointer 76 on the PC 38 or other computing devices, such as a web enabled TV. The sensors 22, 24, 26, 28 on the surface 20 measure force information, the location determiner 72 determines the position of events on the surface 20, and the pointer manager 80 maps these events to states. The processor 30 then sends information identifying the surface 20 and the pointing events to the PC 38 in data packets 54 using the wireless communication device 52. The PC 38 running the mouse emulator 74 controls the behavior of the mouse pointer based on the event information fields 62, 64, 66 in the data packets 54.

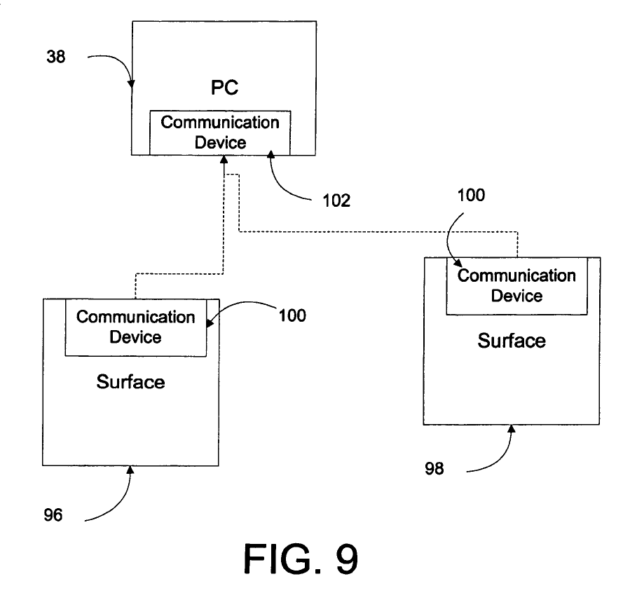

As FIG. 9 shows, multiple surfaces may be used to interface with a computer. For example, a coffee table load sensing surface 96 and a dining table load sensing surface 98 may interface with the PC 38. Each of the surfaces includes a communication device 100 such as a RF transceiver. Data packets 54 including pointing event data 62, 64, 66 are sent from the surfaces 96, 98 to the PC 38, which includes a RF transceiver 102. The surface identifier fields 60 in the data packets 54 inform the PC 38 which surface the pointing event data is originating from. For example, the computer user may use the coffee table 96 to access a web page, walk to the dining table 98 and turn the PC 38 off. The PC 38 may process pointing events from the multiple surfaces 96, 98, as a single stream of events.

A number of implementations have been described. Nevertheless, it will be understood that various modifications may be made. Accordingly, other implementations are within the scope of the following claims.

What is claimed is:

1. A method comprising:
measuring force distribution information at a plurality of points on a substantially continuous surface;
processing the force distribution information to identify events on the surface; and
mapping the events to pointing device behavior.

2. The method of claim 1 wherein processing the force distribution information comprises calculating a center of pressure of a total force on the surface.

3. The method of claim 2 comprising:
detecting an increase in a sum of forces measured at each of the plurality of points;
determining that the increase in the sum of the forces is between a lower threshold and an upper threshold; and
identifying that the surface is being touched, based on the increase in the sum of the forces.

4. The method of claim 3 comprising:
detecting a decrease in the sum of the forces; and
identifying that the surface is no longer being touched, based on the decrease in the sum of the forces.

5. The method of claim 2 comprising:
monitoring changes in the force distribution information at the plurality of points for a period of time;
determining that a sum of the changes for the period of time is less than a threshold; and
identifying that there is no interaction on the surface.

6. The method of claim 2 comprising:
monitoring changes in the force distribution information at the plurality of points for a period of time;
identifying a change in the center of pressure; and
mapping the change in the center of pressure to pointing device movement.

7. The method of claim 2 comprising:
detecting an increase in a sum of forces measured at each of the plurality of points;
detecting a subsequent decrease in the sum of forces measured at each of the plurality of points; and
identifying a mouse click event, based on the increase and subsequent decrease in the sums of forces.

8. The method of claim 2 comprising:
measuring a pre-load force distribution on the surface; and
subtracting the pre-load force distribution from the force distribution information, prior to computing the center of pressure.

9. A system comprising:
a plurality of sensors operable to sense force distribution information at points on a substantially continuous surface; and
a pointer manager operable to map the force distribution information to pointing information.

10. The system of claim 9 further comprising a location determiner operable to determine a center of pressure of the force distribution.

11. The system of claim 9 wherein the surface is rectangular, and the plurality of sensors includes a sensor located at each corner of the rectangular surface.

12. The system of claim 11 further comprising an analog to digital converter that is operable to convert analog signals from the sensors to digital signals.

13. The system of claim 12 further comprising a communication device operable to communicate the digital signals to a computer.

14. The system of claim 13 wherein the communication device includes a RF transceiver.

15. The system of claim 13 wherein the computer includes a mouse emulator to translate the digital signal into mouse pointing events.

16. The system of claim 9 wherein the surface is a table.

17. The system of claim 9 further comprising:
a second set of sensors operable to sense force distribution information at points on a second substantially continuous surface;
a second pointer manager operable to map the force distribution information to pointing information; and
a computer including a mouse emulator operable to translate the force distribution information from the first and second surfaces into a stream of mouse pointing events.

18. An application comprising:
a code segment operable to measure force distribution information at a plurality of points on a substantially continuous surface;
a code segment operable to process the force distribution information to identify events on the surface; and
a code segment operable to map the events to pointing device behavior.

19. The application of claim 18 comprising:
a code segment operable to detect an increase in a sum of forces measured at each of the plurality of points;
a code segment operable to determine that the increase in the sum of the forces is between a lower threshold and an upper threshold; and
a code segment operable to identify that the surface is being touched, based on the increase in the sum of the forces.

20. The application of claim 18 comprising:
a code segment operable to monitor changes in the force distribution information at the plurality of points for a period of time;
a code segment operable to identify a change in a center of force of the object; and
a code segment operable to map the change in the center of force to pointing device movement.

21. The application of claim 18 comprising:
a code segment operable to detect an increase in a sum of forces measured at the plurality of points;
a code segment operable to detect a subsequent decrease in the sum of forces measured at the plurality of points; and
a code segment operable to identify a mouse click event, based on the increase and subsequent decrease in the sums of forces.

22. The application of claim 18 comprising:
a code segment operable to measure a pre-load force distribution on the surface; and
a code segment operable to subtract the pre-load force distribution from the force distribution information prior to computing a center of pressure.
